(19) United States
(12) Patent Application Publication
(10) Pub. No.: US 2014/0148940 A1
(43) Pub. Date: May 29, 2014

(54) System for Remotely Deactivating the Operation of a Machine

(71) Applicant: Kenneth J. SUSNJARA, Birdseye, IN (US)

(72) Inventor: Kenneth J. SUSNJARA, Birdseye, IN (US)

(73) Assignee: Thermwood Corporation

(21) Appl. No.: 13/688,433

(22) Filed: Nov. 29, 2012

(51) Int. Cl. G05B 19/4063

(52) U.S. Cl. CPC G05B 19/4063
USPC 700/177

(57) ABSTRACT

A system for remotely deactivating the operation of a machine tool responsive to an adverse operating condition of the machine, including an electrical circuit disposable in the vicinity of the machine, including a relay, interconnecting a voltage source and the control unit of the machine, functional to pause the control of such machine, a receiver disposable in the vicinity of the machine, responsive to a R-F signal operative to actuate such relay, and a portable device displaceable relative to the vicinity of the machine for selectively transmitting an R-F signal to such transmitter for actuating such relay.

This invention relates to a machine tool and more particularly to as system responsive to a malfunctioning condition in the operation of such machine for deactivating the machine.

### BACKGROUND OF THE INVENTION

CNC routing machines are used in manufacturing processes for routing, drilling, trimming and other operations in forming various workpieces. The automatic nature of such machines allows the machine operator to engage in ancillary tasks during a machining cycle, therefore making efficient use of otherwise idle time. From time to time, in the operation of such machines, any number of uncontrollable events such as tool breakage, dislocation of workpieces and the like could occur while the machine is in an automatic operating mode. Should such a malfunction occur, it would be beyond the capability of the machine control to detect the fault and stop the machine for the purpose of undertaking remedial action. Typically, under such circumstances, the operator must go immediately to the machine, activate a pause or stop function in order to make the required adjustments, observations and/or other corrective procedures.

Manufacturers provide systems such as pressure activated mats, photo-electric beam systems or any number of other sensing devices for the purpose of stopping the machine and providing for safe entry into the machine operating zone. Such systems, however, are costly, often cumbersome in nature and are vulnerable to damage from activities such as loading and/or unloading the machine. Furthermore, because such systems require point-of-contact activation, the amount of time required to gain access to the machine from a remote location could result in damage to a workpiece and/or the machine. More importantly, excessive delay and stopping the machine could result in injury to the operator and/or other personnel in the vicinity of the machine.

Accordingly, the principal object of the present invention is to provide a system permitting a machine operator disposed at a distance from a malfunctioning machine to deactivate the machine from such distance.

### SUMMARY OF THE INVENTION

The principal object of the present invention is achieved by providing a system for remotely deactivating the operation of a machine tool responsive to an adverse condition in the operation of the machine, including an electrical circuit including an electrically actuated relay interconnecting a voltage source and an input port of a control unit of the machine, functional upon closure of such relay to pause the operation of the machine; a receiver responsive to an R-F signal operative to electrically actuate such relay; and means displaceable relative to the electrically actuable means for selectively transmitting an R-F signal to such receiver. Such an adverse condition may consist of a malfunction of a tool, a displacement of a tool or a malfunction of means for retaining a workpiece on the machine. Such relay may be provided in a control unit of the machine apart from a signal receiver provided in a separate module or provided in a separate module with the signal receiver. Preferably, the transmitter consists of a portable, handheld receiver, the range of the receiver is 100 feet, the transmitted signal is coded and the remote receiver includes an encoder.

### BRIEF DESCRIPTION OF THE DRAWING

FIG. 1 is a schematic block diagram of the control unit of a CNC machine incorporating the system of the present invention.

### DETAILED DESCRIPTION OF THE PREFERRED EMBODIMENT OF THE INVENTION

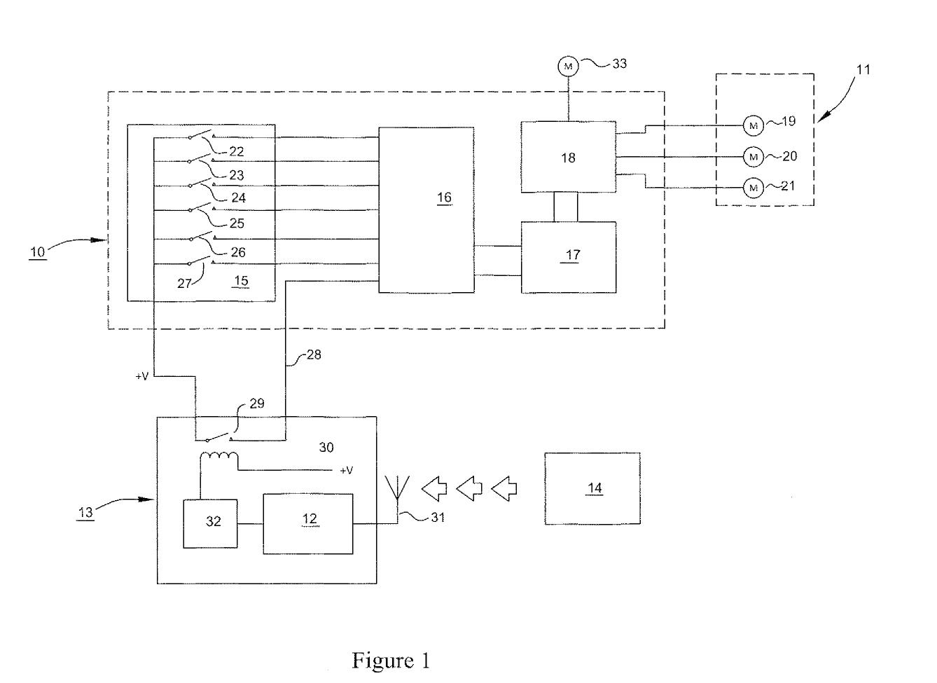

Referring to FIG. 1, there is shown a control unit 10 of a CNC router machine 11 and peripheral components embodying the present including an R-F receiver 12 possibly provided in a module 13 disposed apart from the control and an R-F transmitter 14 disposed separate and apart module 13. Control unit 10 includes a control panel 15, an input/output interface 16, a control computer 17 and a servo drive system 18. CNC machine 11 includes servo drive motors 19, 20 and 21. Control panel 13 includes a number of parallel circuits interconnecting a voltage source and input ports of input/output interface 16, each including one of an emergency stop relay 22, a cycle start relay 23, a feed hold relay 24, a block step retard relay 25, a block stop advance relay 26 and a reset relay 27. Input/output interface 16 is operatively connected to control computer 17 which operates control drive system 18, and drive system 18 functions to drive router spindle motor 28 and displace motors 19, 20 and 21 along x, y and z axes, in the conventional manner.

Module 13 includes a first circuit 28 disposed parallel to the other input circuits of the control panel, interconnecting a voltage source and an input port of input/output interface 16 and includes a relay switch 29, and a second circuit 30 provided with a voltage source, a receiver 12 with an antenna 31 and including a latching logic component 31 and the actuating coil of switch 29. Alternatively, relay switch 29 can be disposed in control panel 15 and may consist of any type of electrically actuating switch including solid state switches. Upon closure of switch 29, computer 17 functions to deactivate the entire machine to permit remedial action with respect to any component malfunction. Upon remedying the malfunction, the operation of the machine may be resumed by triggering reset switch 27. The components of module 13 may be integrated into the control unit of the machine, provided in a separate module mounted on the control unit or placed in a module positioned adjacent the control unit.

Transmitter 14 is a device operatively compatible with receiver 12 to selectively generate a coded R-F signal to activate receiver 12. It is portable so that it can be carried by the machine operator and has a range of 100 feet. Receiver 12 is functional to receive and decode R-F signals generated by transmitter 14, energizing circuit 30, correspondingly closing switch 29 to effect a pause in the operation of a the machine.

In the typical use of a CNC machine equipped with the deactivating system, an operator would load the workpieces to be machined on the worktable of the machine, utilizing various holddown devices including clamps and vacuum devices, input a selected machine program into the control unit of the machine and then actuate a cycle start switch in the control unit to execute the loaded program. Under such operating conditions, the workpieces would be retained in their selected positions, the servo motors would be displaced along the x, y and z axes pursuant to the program being executed, and the motor spindle would be operated to machine the loaded workpieces. With the machine thus operating, the operator would be free to perhaps set up and operate one or more similar machines in the near vicinity, attend to gathering, sorting and transporting machined workpieces to other departments, possibly assembling machine components and otherwise which may cause the operator to depart from the vicinity of the machine under operation.

Upon being distanced from the machine and being alerted to a malfunction of the machine such as a displacement of a workpiece, a broken tool or any other such malfunction, the operator would be able to deactivate the machine simply by triggering his portable transmitter causing switch 29 to close and correspondingly deactivate the machine into a pause condition. Upon return to the vicinity of the machine, determining and remedying the malfunction of the machine, the operator would resume the routine operation of the machine by actuating reset switch 27.

The circuit including pause switch 29 may be integrated in control panel 15 or may be disposed in a module mounted on the control panel or disposed apart from the machine. Depending on the location of pause switch 29, receiver 12 can be integrated into the control panel or provided in a module mounted on the machine or disposed apart from the machine.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

1. A system for remotely deactivating the operation of a machine tool responsive to an adverse condition in the operation of said machine, comprising:
an electrical circuit including an electrically actuated relay interconnecting a voltage source and an input port of a control unit of said machine, functional upon closure of said relay to pause the operation of a sad machine;
a receiver responsive to an R-F signal operative to electrically actuate said relay; and
means displaceable relative to said electrically actuable means for selectively transmitting said R-F signal.

2. The system according to claim 1 wherein said adverse condition is one of a malfunction of a tool, the displacement of a tool and means for retaining a workpiece.

3. The system according to claim 1 wherein said transmitting means is portable.

4. The system according to claim 1 wherein said transmitting means has a range of 100 feet.

5. The system according to claim 1 wherein said transmitting means comprises a hand-held device.

6. The system according to claim 1 wherein said relay is disposed in a control unit of said machine.

7. The system according to claim 6 wherein said receiver is disposed on said machine.

8. The system according to claim 1 wherein said receiver is disposed in a module separate from said machine.

9. The system according to claim 8 wherein said relay is disposed in a control unit of said machine.

10. The system according to claim 8 wherein said relay is disposed in said module.

11. The system according to claim 1 wherein said signal is coded and said receiver includes a decoder.

12. The system according to claim 1 wherein said machine is a CNC machine.

13. The system according to claim 1 wherein said machine is a CNC router.

14. The system according to claim 13 wherein said adverse condition is one of a malfunction of a routing spindle, a servo drive motor and a means for retaining a workpiece on a worktable thereof.

15. The system according to claim 13 wherein said transmitting means is portable.

16. The system according to claim 13 wherein said transmitting means has a range of 100 feet.

17. The system according to claim 13 wherein said relay is disposed in a control panel of said machine.

18. The system according to claim 13 wherein said receiver is disposed in a module separate of said machine.

19. The system according to claim 18 wherein said module includes said relay.

20. The system according to claim 19 wherein said signal is coded and said module includes a decoder.
